(19) United States
(12) Patent Application Publication
(10) Pub. No.: US 2025/0214020 A1
(43) Pub. Date: Jul. 3, 2025

(54) POROUS MEMBER CONTAINING CERAMIC PARTICLES AND METHOD FOR PRODUCING SAME

(71) Applicant: CoorsTek GK, Tokyo (JP)

(72) Inventors: Norihiko SAITO, Kanagawa (JP); Hinako NEGISHI, Kanagawa (JP); Yutaka HASHIMOTO, Kanagawa (JP)

(21) Appl. No.: 19/001,988

(22) Filed: Dec. 26, 2024

(30) Foreign Application Priority Data
Dec. 27, 2023 (JP) 2023-221585
Dec. 4, 2024 (JP) 2024-211028

(51) Int. Cl. B01D 46/30; B01D 39/06; B01D 46/00

(52) U.S. Cl. CPC B01D 46/30; B01D 39/06; B01D 46/0001; B01D 46/0002; B01D 2239/1241

(57) ABSTRACT

A porous member includes a tubular housing that is open at both ends of the housing; a plurality of ceramic particles filled in the housing; and a pair of porous lids that seal the both ends of the housing respectively to enclose the ceramic particles inside the housing, and a method for producing the porous member including: filling, with the plurality of ceramic particles, the tubular housing that is open at the both ends of the housing; and sealing the both ends of the tubular housing respectively with the pair of porous lids to enclose the ceramic particles inside the housing.

### CROSS-REFERENCE TO RELATED APPLICATIONS

This application is based on and claims priority under 35 USC 119 from Japanese Patent Application No. 2023-221585 filed on Dec. 27, 2023, and Japanese Patent Application No. 2024-211028 filed on Dec. 4, 2024.

### TECHNICAL FIELD

The present invention relates to a porous member containing ceramic particles and a method for producing the porous member, and more particularly, to a porous member containing ceramic particles in which ceramic particles are filled in a housing and both ends of the housing are sealed with a porous lid, and a method for producing the porous member.

### BACKGROUND ART

In semiconductor manufacturing equipment, which requires extremely high levels of cleanliness, filters made of various materials are used to remove particles and the like. Among these filters, ceramic filters are particularly widely used due to excellent heat resistance, durability, corrosion resistance, and the like.

A ceramic filter is formed of a ceramic porous body, and for example, a ceramic porous body applicable as a semiconductor treatment member is disclosed in Patent Literature 1. The semiconductor treatment member disclosed in Patent Literature 1 is formed of a ceramic porous sintered body having an overall porosity of 50% or more, with a skeletal portion produced by stirring and foaming having a porosity of 5% or less.

Since the ceramic filter is a porous body and thus has particularly low brittleness, the ceramic filter may be chipped during handling. Therefore, in order to facilitate handling of the ceramic filter, a housing is attached to the ceramic filter before the ceramic filter is incorporated into semiconductor manufacturing equipment.

That is, a main body of a ceramic porous body having interconnected cells is accommodated in a housing (such as a hollow cylindrical outer tube) to be incorporated into semiconductor manufacturing equipment.

Patent Literature 2 discloses a method for producing a composite member including a ceramic porous body and a dense ceramic body surrounding the ceramic porous body.

Specifically, when the ceramic porous body and a ceramic surrounding member surrounding the ceramic porous body are integrated, a sintered body is used as the ceramic porous body and a pre-fired molded body is used as the ceramic surrounding member, and the porous body and the surrounding member are assembled.

The assembled porous body and surrounding member are then fired at high temperature, and the ceramic porous body and the dense ceramic body surrounding the ceramic porous body are integrated together by the sintering of the porous body and the surrounding member and a mechanical bonding force due to the sintering shrinkage of the surrounding member molded body, thereby producing a composite member.

### PATENT LITERATURE

Patent Literature 1: JP3894365B
Patent Literature 2: JP2003-238267A

### SUMMARY OF INVENTION

As disclosed in Patent Literature 2, in the method for producing a composite member including a ceramic porous body and a dense ceramic body surrounding the ceramic porous body, the ceramic porous body of a main body is a ceramic porous sintered body produced by stirring and foaming, similar to the ceramic porous body disclosed in Patent Literature 1.

However, in the case of a porous body produced to have a porosity of 50% or more by stirring and foaming, a skeletal portion of pores in which bubble-like pores are interconnected has to be extremely thin, and there is a problem that particles are likely to be generated due to particle shedding.

On the other hand, if the skeletal portion is produced such that the skeletal portion is not thin in order to reduce the generation of particles, the porosity becomes smaller and the air permeability becomes poor, creating a new problem that it takes a long time to ventilate even when the porous body is attached to an exhaust part or the like of a device.

In addition, when a main body of a ceramic porous body is accommodated in a housing, in the method disclosed in Patent Literature 2, the ceramic porous body may be broken during firing at a portion where the ceramic cylinder and the ceramic porous body are in contact with each other.

The present invention has been made in view of the above circumstances. A new porous member and a method for producing the porous member have been studied without using a ceramic porous sintered body produced by stirring and foaming, and the present invention has been conceived and completed.

An object of the present invention is to provide a new porous member using ceramic particles and a method for producing the porous member, that is, a porous member containing ceramic particles and a method for producing the porous member, and the present invention can reduce the generation of particles, or can reduce the pressure loss due to good air permeability.

The porous member containing ceramic particles according to an aspect of the present invention includes: a tubular housing open at both ends; a plurality of ceramic particles filled in the housing; and a pair of porous lids configured to seal both ends of the tubular housing to enclose the ceramic particles inside the housing.

Since the porous member containing ceramic particles configured as described above is not a porous body produced by stirring and foaming but is constituted by a plurality of ceramic particles filled in the housing, there is no thin portion that is generated when a main body of a conventional porous body is formed by stirring and foaming, and it is possible to reduce the generation of particles due to the shedding of particles from the thin portion.

Alternatively, in the porous member containing ceramic particles according to the present invention, by setting an average pore size of the porous lids and a particle size of the ceramic particles within specific ranges, good air permeability can be obtained, and pressure loss can be reduced.

Preferably, the ceramic particles have a particle size of 100 μm or more and 800 μm or less. A filling region ratio of the ceramic particles is preferably 34% or more and 95% or less with respect to a length connecting both ends of the housing. Preferably, the porous lids have an average pore size (an average pore diameter) of 22 μm or more and 200 μm or less and a porosity (a degree of porosity) of 20% or more and 40% or less.

As described above, by setting the particle size of the ceramic particles to 100 μm or more and 800 μm or less, more preferably 600 μm or more and 800 μm or less, setting the filling region ratio of the ceramic particles in the housing to 34% or more and 95% or less with respect to the length connecting both ends of the housing, and setting the average pore size of the porous lids to 22 μm or more and 200 μm or less, it is possible to improve the air permeability and reduce the pressure loss.

In order to solve the above problems, the method for producing the porous member containing ceramic particles according to the present invention includes filling a plurality of ceramic particles into a tubular housing open at both ends; and sealing both ends of the tubular housing with a pair of porous lids to enclose the ceramic particles inside the housing.

According to such a method, the porous member containing ceramic particles of the present invention can be produced.

According to the present invention, it is possible to obtain a porous member containing ceramic particles, which can reduce the generation of particles or can reduce the pressure loss due to good air permeability, and a method for producing the porous member.

### BRIEF DESCRIPTION OF DRAWINGS

FIG. 1 is a cross-sectional view schematically showing a configuration of a porous member according to the present invention.

FIGS. 2A, 2B, 2C and 2D are cross-sectional views for explaining a method for producing the porous member of FIG. 1.

FIG. 3 is a diagram showing a schematic configuration of an evaluation device for evaluating examples and comparative examples.

### DETAILED DESCRIPTION OF THE INVENTION

Hereinafter, a porous member containing ceramic particles according to the present invention and a method for producing the porous member will be described with reference to the drawings.

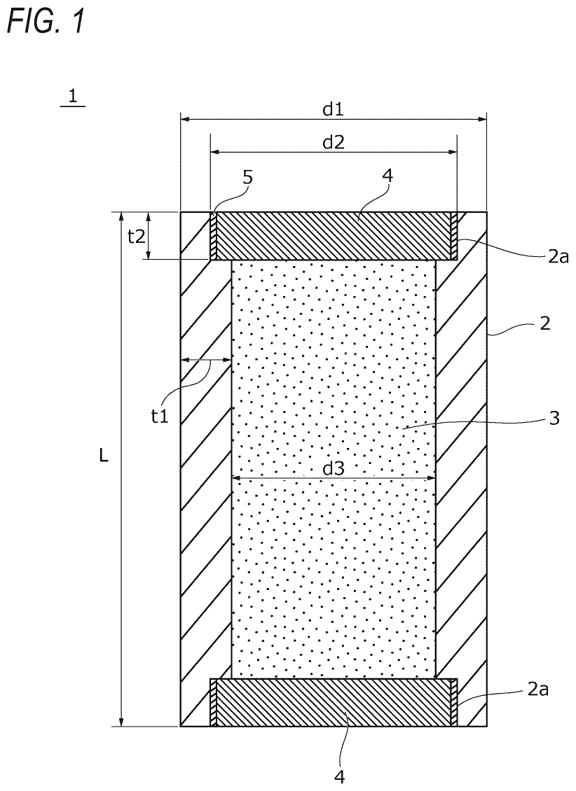

FIG. 1 is a cross-sectional view schematically showing a configuration of the porous member containing ceramic particles according to the present invention. A porous member 1 containing ceramic particles shown in FIG. 1 can be used as, for example, a ceramic filter using continuous pores, a heat insulating material using a structure including pores, a light diffusion plate that uniformly spreads and transmits light, or a member for semiconductor manufacturing equipment used in a plasma treatment step or the like.

The porous member 1 containing ceramic particles of FIG. 1 includes a tubular outer tube member 2 open at both ends, ceramic particles 3 filled in the outer tube member 2, and a pair of porous lids 4 that seal both ends of the outer tube member 2. That is, the ceramic particles 3 are accommodated and filled in the outer tube member 2 as a housing.

The outer tube member 2 is preferably made of a resin having high heat resistance, a resin (for example, Teflon (registered trademark)) having low dielectric constant, or quartz. The outer tube member 2 is formed to have a diameter (outer diameter) d1 of 50 mm, a length L of 80 mm, and a thickness t1 of 5 mm, for example.

The outer tube member 2 is not limited to a cylindrical shape, and may be a square tube shape having a polygonal cross section.

The ceramic particles 3 filled in the outer tube member 2 are simply accommodated and filled in the outer tube member 2. The ceramic particles 3 are preferably made of silica and are preferably in the form of crushed powder or spherical.

In addition, a filling region ratio of the ceramic particles 3 in the outer tube member 2 is 34% or more and 95% or less with respect to a length L connecting both ends of the outer tube member 2.

The filling region ratio means a length between the pair of porous lids inside the outer tube member, that is, a length filled with the ceramic particles, with respect to the length L connecting both ends of the outer tube member 2. Here, when the length L connecting both ends of the outer tube member 2 is set to a specific length, a ratio (length) of the porous lids 4 increases as the filling region ratio decreases. On the other hand, as the filling region ratio increases, the ratio (length) of the porous lids 4 decreases.

When the filling region ratio of the ceramic particles 3 in the outer tube member 2 is less than 34%, the ratio of the porous lids 4 to the length L connecting both ends of the outer tube member 2 increases, and the pressure loss may increase.

When the filling region ratio of the ceramic particles 3 in the outer tube member 2 exceeds 95%, the ratio of the porous lid 4 to the length L connecting both ends of the outer tube member 2 becomes small, and the porous lids 4 may be damaged.

The ceramic particles 3 preferably have a maximum particle size of 800 μm or less.

When the maximum particle size exceeds 800 μm, gaps between the particles becomes large, an intramolecular force between the particles becomes weak, and the particles become more likely to move within the outer tube member, which may break (damage) the porous lids. When the porous member 1 is used as a light diffusion plate or a heat insulating material, the heat insulating effect or the light diffusion effect may be weakened.

In order to reduce the pressure loss, a minimum particle size of the ceramic particles 3 is preferably 100 μm or more, and more preferably 600 μm or more.

Therefore, a desirable range of the particle size of each of the ceramic particles 3 is 100 μm or more and 800 μm or less, and more preferably 600 μm or more and 800 μm or less.

The ceramic particles 3 can be classified using a sieve. For example, ceramic particles of 600 μm or more and 800 μm or less can be classified using sieves having mesh sizes of 600 μm and 800 μm. That is, ceramic particles of 600 μm or more and 800 μm or less can be obtained as ceramic particles that pass through a sieve having a mesh size of 800 μm but do not pass through a sieve having a mesh size of 600 μm.

The pair of porous lids 4 for sealing openings at both ends of the outer tube member 2 to enclose the ceramic particles 3 inside the outer tube member 2 are made of a porous resin or silica. Outer peripheral portions of the porous lids 4 are bonded to an inner peripheral surface of the outer tube member 2.

Specifically, counterbores 2a are formed on the inner peripheral surface at both ends of the outer tube member 2, and side surfaces of the counterbores 2a are filled with an adhesive 5. That is, the porous lids 4 are bonded to the inner peripheral surface of the outer tube member 2 via the adhesive 5.

Here, although a case where the counterbores 2a are formed on the inner peripheral surface at both ends of the outer tube member 2 has been described, the present invention is not particularly limited to the counterbores 2a, and a step portion filled with the adhesive 5 may be formed in the porous lids 4, or the outer tube member 2 and the porous lids 4 may be bonded without forming a step portion in either of the outer tube member 2 or the porous lids 4.

The adhesive 5 is not particularly limited as long as it has heat resistance, and for example, an epoxy-based or silica-based adhesive can be used.

In a case where the porous lids 4 are made of a resin, the porous lids 4 can be made of, for example, PTFE. In a case where the porous lids 4 are made of silica, the porous lids 4 can be formed by, for example, a sol-gel method.

An average pore size of each of the porous lids 4 is preferably 22 μm or more and 200 μm or less, and a porosity thereof is preferably 20% or more and 40% or less. When the average pore size is less than 22 μm or the porosity is less than 20%, good air permeability may not be obtained and the pressure loss may increase.

On the other hand, when the average pore size exceeds 200 μm or the porosity exceeds 40%, there is a high risk of particle generation.

The average pore size and the porosity of the porous lid can be determined by measurement using a mercury porosimeter, in the same manner as the average pore size and the porosity of the porous body.

A ratio of the average pore size of the porous lid to the particle size of the ceramic particles is preferably 1:1.1 to 1:80.

When the ratio of the average pore size of the porous lid to the particle size of the ceramic particles is 1:1.1 to 1:80, good air permeability can be obtained, and the pressure loss can be reduced.

A thickness t2 of each of the porous lids 4 is preferably 2 mm or more and 20 mm or less. When the thickness t2 of the porous lid 4 is less than 2 mm, the porous lid 4 may be damaged because the strength becomes weak. On the other hand, when the thickness t2 of the porous lid 4 exceeds 20 mm, the pressure loss may increase.

A planar shape of the porous lid 4 is formed to match a cross-sectional shape of the outer tube member 2.

The porous member 1 configured as described above does not have a porous body produced by stirring and foaming, but is formed of a plurality of ceramic particles 3 filled in the outer tube member 2.

Further, since the porosity of the porous lid 4 sealing both ends of the outer tube member 2 is 20% or more and 40% or less, there is no thin portion that is generated when a main body of a conventional porous body is formed by stirring and foaming, and it is possible to reduce the generation of particles due to the shedding of particles from the thin portion.

In particular, by setting the particle size of the ceramic particles 3 to preferably 100 μm or more and 800 μm or less, and more preferably 600 μm or more and 800 μm or less, setting the filling region ratio of the ceramic particles 3 to the outer tube member 2 to 34% or more and 95% or less with respect to the length L connecting both ends of the outer tube member 2, and setting the average pore size of the porous lid 4 to preferably 22 μm or more and 200 μm or less, and more preferably 22 μm or more and 150 μm or less, it is possible to improve the air permeability and reduce the pressure loss.

Since the ceramic particles 3 filled in the outer tube member 2 are simply accommodated and filled in the outer tube member 2, no large gaps are generated between the outer tube member 2 and the ceramic particles 3. Since the ceramic particles 3 are not fired after being accommodated and filled in the outer tube member 2, it is possible to prevent the ceramic particles 3 in close contact with the outer tube member 2 from being damaged.

The ceramic particles 3 filled in the outer tube member 2 may be fixed. As a fixing method, a method of filling the ceramic particles 3 in a state in which a photocurable adhesive or the like is applied to the ceramic particles 3 in advance can be used. By fixing the ceramic particles 3, there is no displacement even when vibration is applied after filling.

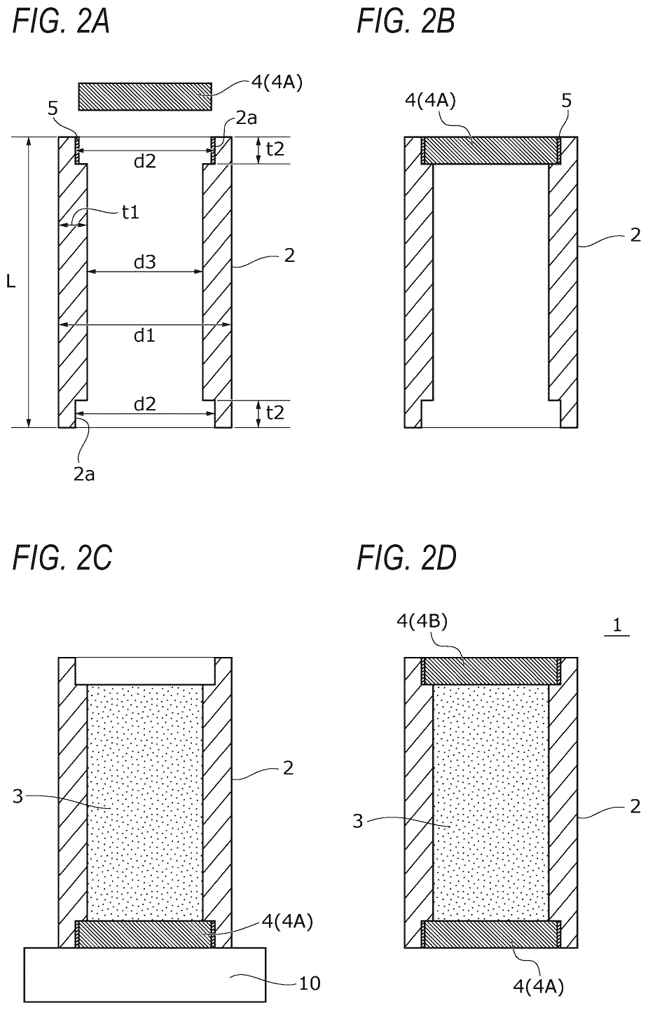

Next, a method for producing the porous member containing ceramic particles according to the present invention will be described with reference to FIGS. 2A, 2B, 2C and 2D.

First, the counterbores 2a are formed on the inner peripheral surface at both ends of the outer tube member 2 made of a resin (for example, Teflon) having high heat resistance, or quartz. The outer tube member 2 is formed to have, for example, a diameter (outer diameter) d1 of 50 mm, an inner diameter d3 of 40 mm, a length L of 80 mm, and a thickness t1 of 5 mm, and the counterbores 2a are each formed to have a diameter d2 of 42 mm and a depth t2 of 5 mm.

Then, as shown in FIG. 2A, an epoxy-based adhesive 5 is applied to the side surface of the counterbore 2a of the porous member 1, and as shown in FIG. 2B, the porous lid 4 is attached to the porous member 1 and dried at 80° C. for 3 hours.

The porous lid 4 is formed in advance such that an outer shape of the porous lid 4 in plan view matches a shape of the counterbore 2a of the outer tube member 2, an outer diameter of the porous lid 4 substantially matches an inner diameter of the counterbore 2a of the outer tube member 2, and the porous lid 4 can be fitted to the end of the outer tube member 2.

Next, as shown in FIG. 2C, the outer tube member 2 is placed upside down on a vibrator 10 (for example, product name: VIBRATORY PACKER).

As a result, the previously bonded porous lid 4 (4A) is disposed at a bottom portion of the outer tube member 2.

Then, the ceramic particles 3 are poured into the outer tube member 2 until the ceramic particles 3 reach the same level as a bottom surface of the counterbore 2a.

Next, the vibrator 10 is operated to vibrate at a frequency of 60 Hz for approximately one minute. When an upper surface of the poured ceramic particles is lowered, ceramic particles are added and replenished, and the vibrator 10 is operated again at a frequency of 60 Hz for approximately one minute. Further, the addition and replenishment of ceramic particles and the vibration by the vibrator 10 are repeated until the upper surface of the poured ceramic particles after the vibration reach the same level as the bottom surface of the counterbore 2a.

As a result, large gaps between the ceramic particles 3 filled in the outer tube member 2 are eliminated, and the gaps between the ceramic particles 3 are uniform.

Then, as shown in FIG. 2D, the epoxy-based adhesive 5 is applied to the side surface of the counterbore 2a of the porous member 1, and the porous lid 4 (4B) is attached to the porous member 1 and dried at 80° C. for 3 hours.

By performing the above steps, the porous member 1 containing the ceramic particles shown in FIG. 1 is produced.

In the porous member produced in this manner, the ceramic particles 3 having a particle size of 100 μm or more and 800 μm or less, more preferably 600 μm or more and 800 μm or less are poured, and finally, the filling region ratio of the ceramic particles 3 in the outer tube member 2 is set to 34% or more and 95% or less with respect to the length L connecting both ends of the outer tube member 2.

### EXAMPLES

Hereinafter, the porous member containing ceramic particles according to the present invention and the method for producing the porous member will be further described based on examples.

### Example 1

In Example 1, the porous member 1 containing ceramic particles having the structure shown in FIG. 1 was used. As specific conditions, the particle size of the ceramic particles 3 was set to 600 μm to 800 μm (average particle size: 700 μm). The outer tube member 2 used has a diameter (outer diameter) d1 of 50 mm, an inner diameter d3 of 40 mm, a length L of 80 mm, and a thickness t1 of 5 mm, in which the counterbore 2a has a diameter d2 of 42 mm and a depth t2 of 5 mm.

The filling region ratio of the ceramic particles in the outer tube member 2 was set to 88% with respect to the length L connecting both ends of the outer tube member 2.

The porous lid 4 was made of silica by a sol-gel method, and has an average pore size of 38 μm and a porosity of 40%. The porous lid 4 was formed in advance such that the outer shape of the porous lid 4 in plan view matches the shape of the counterbore 2a of the outer tube member 2, the outer diameter of the porous lid 4 substantially matches the inner diameter of the counterbore 2a of the outer tube member 2, and the porous lid 4 can be fitted to the end of the outer tube member 2.

N₂ gas was flowed into the porous member 1 from the porous lid 4A at one end of the porous member 1 at a flow rate of 50 ml (milliliters)/min (minute), and discharged from the porous lid 4B at the other end of the porous member 1 to measure the pressure loss (Pa).

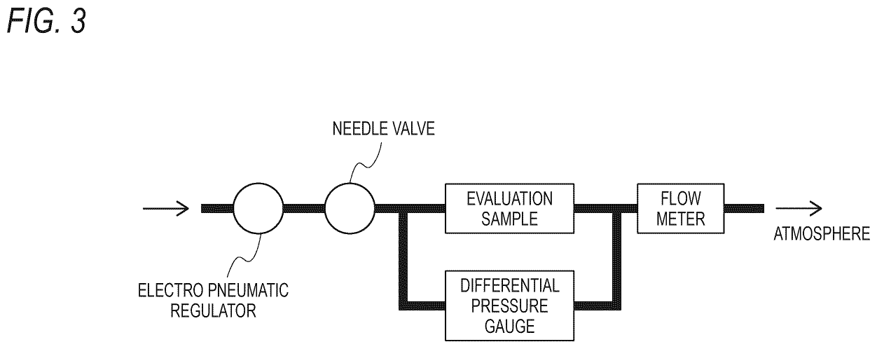

The line shown in FIG. 3 was used for the measurement. While watching a flow meter, nitrogen was flowed at a specified flow rate and a differential pressure at that time was read with a differential pressure gauge to evaluate the pressure loss. In addition, the number of particles detected in one minute was counted using an air particle counter to evaluate the particles. The results of Example 1 are shown in Table1.

### Comparative Example 1

In Comparative Example 1, a cylindrical porous body having an average pore size of 150 μm, a diameter of 40 mm and a length of 80 mm was formed by a sol-gel method using silica powder (average particle size: 600 μm). The porous body was inserted into an outer tube member having the same shape as that of Example 1 (diameter d1 was 50 mm, inner diameter d3 was 40 mm, and length L was 80 mm), and the pressure loss and the number of particles were measured under the same conditions as in Example 1. The results of Comparative Example 1 are shown in Table 1.

### Examples 2 to 9

Particles were evaluated by counting the number of particles in the same manner as in Example 1 except that the average pore size of the porous lid and the particle size of the ceramic particles were changed as shown in Table 1. N₂ gas was flowed into the porous member 1 from the porous lid 4A at one end of the porous member 1 at a flow rate of 50 ml (milliliters)/min (minute), and discharged from the porous lid 4B at the other end of the porous member 1 to measure the pressure loss (Pa).

TABLE 1

| | | | | | Filling region | | |
|---|---|---|---|---|---|---|---|
| | Average pore size | | | | ratio of ceramic | | |
| | (μm) of porous lid | | | Average | particles (ratio to | | Differential |
| | (porous body in | Porosity of | Particle size | particle size of | length L of outer | Particle | pressure at |
| | Comparative | porous lid | of ceramic | ceramic | tube member) | generation | flow rate of 50 |
| | Example 1) | (%) | particles (μm) | particles (μm) | (%) | (particles) | ml/min (Pa) |
| Comparative | 150 | 40 | — | 600 | — | 30 | 160 |
| Example 1 | | | | | | | |
| Example 1 | 38 | 40 | 600 to 800 | 700 | 88 | 0 | 90 |
| Example 2 | 84 | 40 | 500 to 700 | 600 | 88 | 0 | 41 |
| Example 3 | 100 | 40 | 120 to 200 | 160 | 88 | 0 | 34 |
| Example 4 | 100 | 40 | 100 to 200 | 150 | 88 | 0 | 216 |
| Example 5 | 150 | 40 | 200 to 400 | 300 | 88 | 30 | 108 |
| Example 6 | 150 | 40 | 600 to 800 | 700 | 88 | 30 | 23 |
| Example 7 | 22 | 40 | 600 to 800 | 700 | 88 | 0 | 155 |
| Example 8 | 22 | 40 | 100 to 200 | 150 | 88 | 0 | 155 |
| Example 9 | 20 | 40 | 100 to 200 | 150 | 88 | 0 | 171 |

In all of Examples 1 to 9, no large gaps were formed between the housing and the ceramic particles, and no damage was observed between the housing and the ceramic particles.

In Examples 1 to 9, excluding Examples 4 and 9, as shown in Table 1, the pressure loss at the N₂ gas flow rate in Example 1 was lower than that in Comparative Example 1 (conventional porous body).

In addition, in all of Examples 1 to 9, the number of particles generated was equal to or less than the number of particles generated in Comparative Example 1.

In particular, in Examples 1 to 9, excluding Examples 4 and 9, both a decrease in the number of particles generated and a decrease in the differential pressure, which were observed in Comparative Example 1, were observed.

### Examples 10 to 13

Particles were evaluated by counting the number of particles in the same manner as in Example 1 except that the average pore size of the porous lid and the filling region ratio of the ceramic particles were changed as shown in Table 2. N₂ gas was flowed into the porous member 1 from the porous lid 4A at one end of the porous member 1 at a flow rate of 50 L/min, and discharged from the porous lid 4B at the other end of the porous member 1 to measure the pressure loss (Pa).

The results are shown in Table 2.

TABLE 2

| | | | | Average | | | Differential |
|---|---|---|---|---|---|---|---|
| | Average pore | Porosity of | Particle size | particle size of | Filling region | Particle | pressure at flow |
| | size of porous | porous lid | of ceramic | ceramic | ratio of ceramic | generation | rate of 50 ml/min |
| | lid (μm) | (%) | particles (μm) | particles (μm) | particles (%) | (particles) | (Pa) |
| Example 10 | 38 | 40 | 600 to 800 | 700 | 30 | 0 | 410 |
| Example 11 | 38 | 40 | 600 to 800 | 700 | 95 | 0 | 32 |
| Example 12 | 38 | 40 | 600 to 800 | 700 | 75 | 0 | 158 |
| Example 13 | 100 | 40 | 600 to 800 | 700 | 34 | 0 | 158 |

In all of Examples 10 to 13, no large gaps were formed between the housing and the ceramic particles, and no damage was observed between the housing and the ceramic particles.

As shown in Table 2, when the filling region ratio of the ceramic particles was 34% to 95% (Examples 11 to 13), a decrease in the differential pressure was observed compared to Comparative Example 1.

### Examples 14 to 20

Particles were evaluated by counting the number of particles in the same manner as in Example 1 except that the average pore size of the porous lid and the porosity of the porous lid were changed as shown in Table 3. N₂ gas was flowed into the porous member 1 from the porous lid 4A at one end of the porous member 1 at a flow rate of 50 ml (milliliters)/min (minute), and discharged from the porous lid 4B at the other end of the porous member 1 to measure the pressure loss (Pa).

The results are shown in Table 3.

TABLE 3

| | Average | | Filling | | |
|---|---|---|---|---|---|
| | pore | | region | | Differential |
| | size of | Porosity | ratio of | | pressure |
| | porous | of | ceramic | Particle | at flow rate |
| | lid | porous | particles | generation | of 50 ml/min |
| | (μm) | lid (%) | (%) | (particles) | (Pa) |
| Example 14 | 10 | 30 | 88 | 0 | 342 |
| Example 15 | 200 | 30 | 88 | 50 | 17 |
| Example 16 | 100 | 20 | 88 | 0 | 34 |
| Example 17 | 100 | 40 | 88 | 0 | 34 |
| Example 18 | 100 | 45 | 88 | 30 | 34 |
| Example 19 | 22 | 20 | 88 | 0 | 155 |
| Example 20 | 20 | 40 | 88 | 0 | 171 |

In all of Examples 14 to 20, no large gaps were formed between the housing and the ceramic particles, and no damage was observed between the housing and the ceramic particles.

As shown in Table 3, when the average pore size of the porous lid was 22 μm to 200 μm or the porosity of the porous lid was 20% to 40%, a decrease in the number of particles generated or a decrease in the differential pressure was observed compared to Comparative Example 1.

### REFERENCE SIGNS LIST

1 porous member containing ceramic particles
2 outer tube member (housing)
3 ceramic particles
4 porous lid

What is claimed is:

1. A porous member comprising:
a tubular housing that is open at both ends of the housing;
a plurality of ceramic particles filled in the housing; and
a pair of porous lids that seal the both ends of the housing respectively to enclose the ceramic particles inside the housing.

2. The porous member according to claim 1, wherein
the ceramic particles have a particle size of 100 μm or more and 800 μm or less.

3. The porous member according to claim 1, wherein
a filling region ratio of the ceramic particles in the housing is 34% or more and 95% or less with respect to a length connecting the both ends of the housing.

4. The porous member according to claim 2, wherein
a filling region ratio of the ceramic particles in the housing is 34% or more and 95% or less with respect to a length connecting the both ends of the housing.

5. The porous member according to claim 1, wherein
each of the porous lids has an average pore size of 22 μm or more and 200 μm or less and a porosity of 20% or more and 40% or less.

6. The porous member according to claim 2, wherein
each of the porous lids has an average pore size of 22 μm or more and 200 μm or less and a porosity of 20% or more and 40% or less.

7. The porous member according to claim 3, wherein
each of the porous lids has an average pore size of 22 μm or more and 200 μm or less and a porosity of 20% or more and 40% or less.

8. The porous member according to claim 4, wherein
each of the porous lids has an average pore size of 22 μm or more and 200 μm or less and a porosity of 20% or more and 40% or less.

9. A method for producing the porous member according to claim 1, the method comprising:
filling, with the plurality of ceramic particles, the tubular housing that is open at the both ends of the housing; and
sealing the both ends of the tubular housing respectively with the pair of porous lids to enclose the ceramic particles inside the housing.
